(19) United States
(12) Patent Application Publication
(10) Pub. No.: US 2010/0133073 A1
(43) Pub. Date: Jun. 3, 2010

(54) CONTROL STRUCTURE FOR MULTI-INSTRUCTION SWITCHES

(76) Inventor: Tsui-Jung SU, Taipei Hsien (TW)

Correspondence Address: Muncy, Geissler, Olds & Lowe, PLLC, 4000 Legato Road, Suite 310, FAIRFAX, VA, 22033, US

(21) Appl. No.: 12/327,377

(22) Filed: Dec. 3, 2008

(51) Int. Cl. H01H 9/00

(52) U.S. Cl. 200/4

(57) ABSTRACT

A control structure for multi-instruction switches includes a base board, a rotary switch located on the base board and a plurality of directional switches located on the periphery of the rotary switch. The base board has a click member located thereon that has a plurality of click portions corresponding to the directional switches. The click member has an action member to drive the rotary switch. The action member and the rotary switch are interposed by an elastic support element to form a gap between the action member and the click member in regular conditions. The action member can drive the rotary switch to rotate on a rotary track to output rotational commands without interfering the click member to avoid mistakenly hitting the directional switches. The action member receives depressing force to compress the elastic support element to drive the click member and compress the directional switches to output directional commands.

### FIELD OF THE INVENTION

The present invention relates to a control structure for multi-instruction switches, and particularly to a control structure adopted for use on a multi-instruction switch to output rotational and directional commands.

### BACKGROUND OF THE INVENTION

Multi-instruction switches are widely used nowadays on various types of information appliance products, such as mobile phones, PDAs, computer keyboards and the like to generate multiple sets of signals. Through a single switch multiple actions can be executed. Thus the size of the information products can be shrunk to improve use convenience.

Among the multi-instruction switches, rotary switches and directional switches are most commonly adopted at present. Taiwan patent No. I296121 discloses a rotary switch and a housing coupled together. The housing and the rotary switch have respectively a latch portion and a latch trough corresponding to each other and latched. The housing can be rotated under an external force, and the latch portion and the latch trough are driven to turn the rotary switch to move on a rotary track so that an internal signal assembly can output a corresponding command signal according to the motion of the rotary switch. China patent No. CN201117533 includes a circuit board and an annular button. The circuit board has a plurality of command switches. The annular button is located on the circuit board and has a plurality of action portions corresponding to the command switches. When the annular button is depressed, the action portions compress the command switches on the circuit board to output corresponding command signals.

However, the aforesaid rotary switch and directional switch can merely provide rotational and directional commands. Their functions are not adequate for more complex electronic devices. To meet such requirements, a technique that integrates the rotary switch and directional switch has been developed to output both rotational commands and directional commands. For instance, U.S. Pat. No. 7,119,290 includes a directional switch and a rotary switch. It has a printed circuit board (PCB) with a plurality of buttons located thereon, such as a central button and upper, lower, left and right buttons that are depressible to output directional commands. The rotary switch is located on the periphery of the PCB and can be rotated to output rotary commands. As the rotary switch is located on the periphery in a concentric manner, rotating the rotary switch is prone to touch the directional switch. Moreover, depressing the directional switch also is prone to turn the rotary switch. Hence operational problems easily occur and faulty output commands caused by operation errors frequently happen.

### SUMMARY OF THE INVENTION

The primary object of the present invention is to solve the aforesaid disadvantages and improve the accuracy of output commands and prevent delivery of erroneous output commands due to faulty operations.

To achieve the foregoing object, the invention provides a control structure for multi-instruction switches that includes a base board, a click member located on the base board and an action member located on the click member. The base board has a rotary switch and a plurality of directional switches located on the periphery of the rotary switch. The click member and the base board have respectively a first anchor portion and a second anchor portion to form a positional relationship for installing on the base board. The click member has a housing opening corresponding to the rotary switch and a plurality of click portions corresponding to the directional switches. The action member and the click member have respectively a first coupling portion and a second coupling portion to form coupling on the click member. The action member and the rotary switch also have respectively a first fastening portion and a second fastening portion corresponding to each other to form fastening relationship therewith. The action member and the rotary switch are interposed by an elastic support element which supports the action member in regular conditions to form a gap between the action member and the click member. Thus the action member can drive the rotary switch to move on a rotary track to output rotational commands without interfering the click member to avoid mistaken touching the directional switches. Moreover, the action member can receive a depressing force to generate a click displacement to compress the elastic support element to drive the directional switch to output a directional command in the depression direction of the click member. The action member and the click member are positioned in a stacked manner through the first and second coupling portions. Thus the size can be shrunk and more space can be saved. In addition, with the elastic support element supporting the action member in the regular conditions, erroneous hitting of the multi-instruction switch during operation can be avoided and accuracy of command output can be improved.

In short, compared with the conventional techniques, the invention provides many benefits, notably:

1. Improve command output accuracy to facilitate user operation.

2. Have a smaller size and is adaptable to smaller electronic devices.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of the invention.

FIG. 2 is a fragmentary exploded view of the invention.

FIGS. 3A and 3B are exploded views of the invention.

FIG. 4 is a cross section of the invention.

FIG. 5 is a schematic view of the invention in a use condition.

FIG. 6 is another cross section of the invention.

FIG. 7 is a schematic view of the invention in another use condition.

FIG. 8 is a schematic view of the invention in yet another use condition.

### DETAILED DESCRIPTION OF THE PREFERRED EMBODIMENT

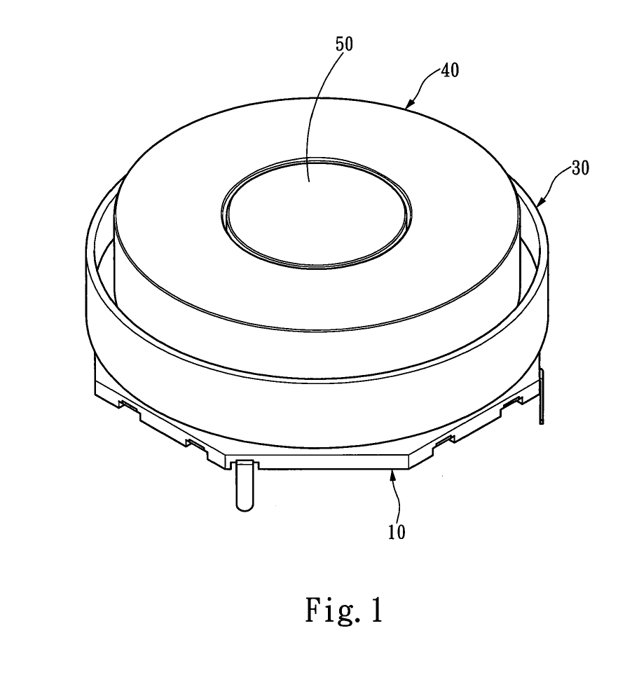

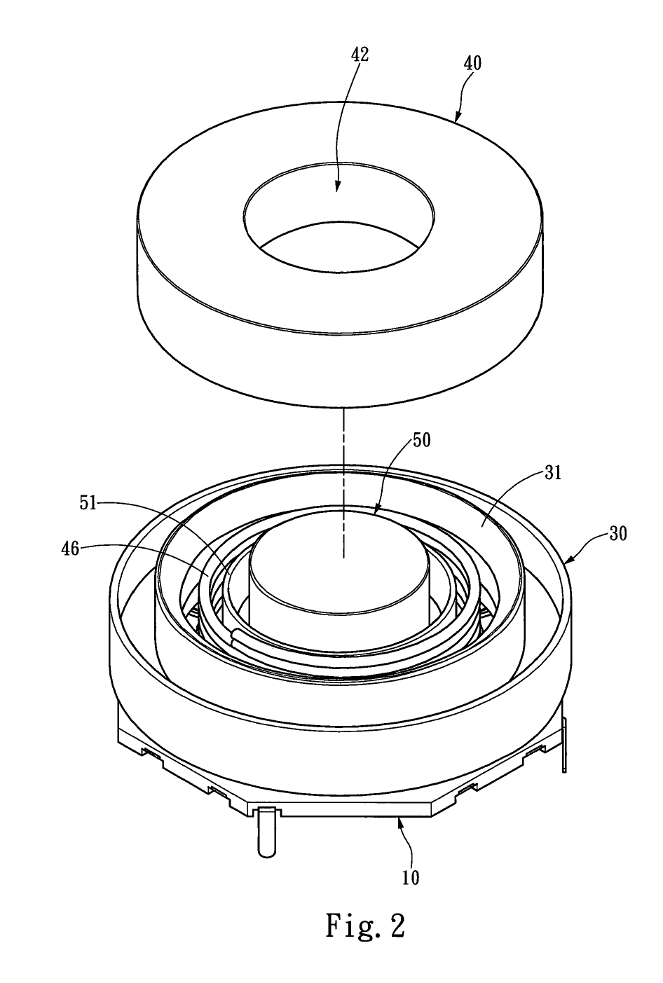

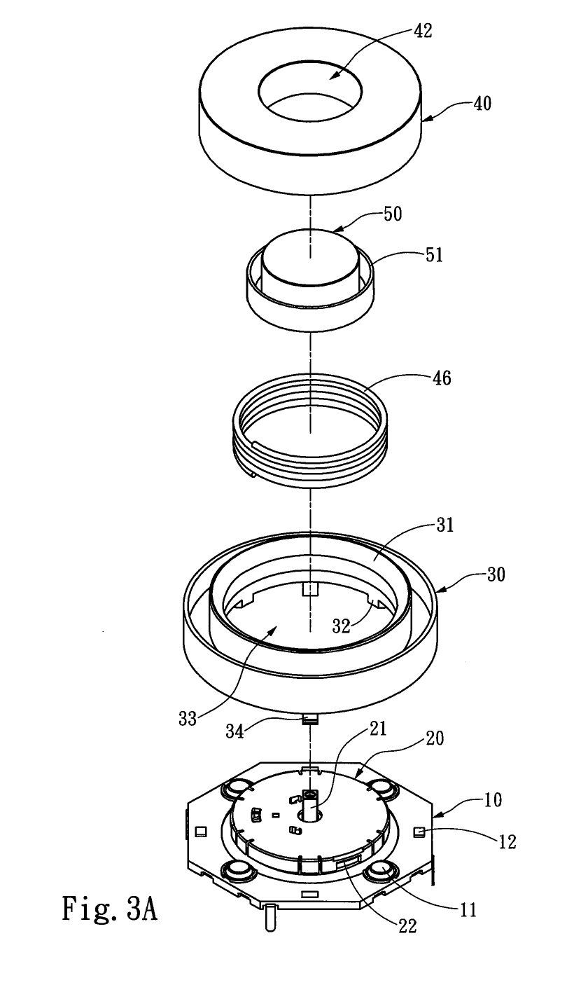

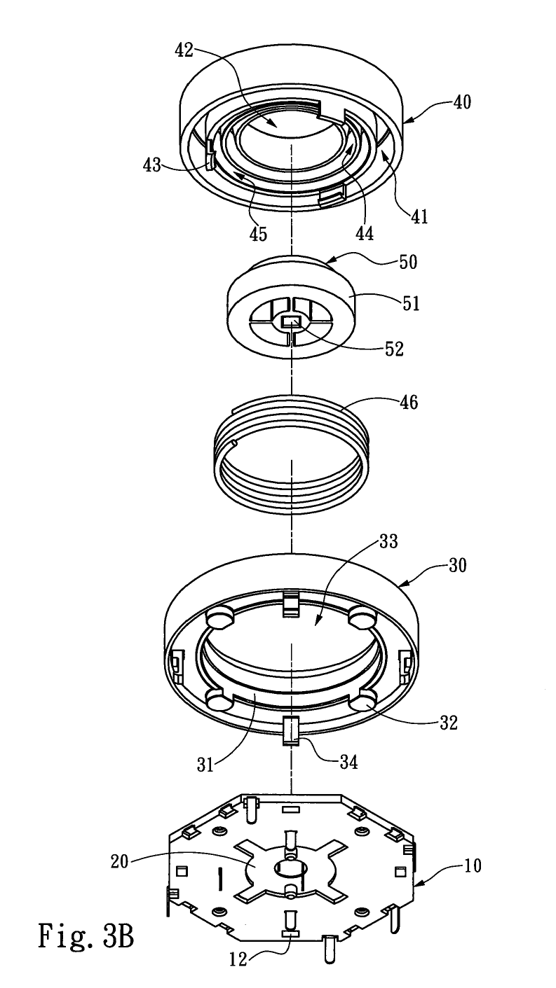

Please refer to FIGS. 1 through 3B, the control structure for multi-instruction switches according to the invention mainly includes a base board 10, a click member 30 and an action member 40. The base board 10 has a rotary switch 20. On the periphery of the rotary switch 20 are a plurality of directional switches 11. The click member 30 is located on the base board 10 and has a plurality of click portions 32 corresponding to the directional switches 11 on the base board 10 and a housing opening 33 corresponding to the rotary switch 20. The click member 30 and the base board 10 have respectively a first anchor portion 34 and a second anchor portion 12 to form a positioning relationship. As shown in the drawings, the first anchor portion 34 and the second anchor portion 12 are respectively a latch hook and a latch hole that are latchable with each other. The action member 40 is located on the click member 30. The action member 40 and the click member 30 have respectively a first coupling portion 41 and a second coupling portion 31 to couple with each other. As shown in the drawings, the first coupling portion 41 and the second coupling portion 31 are respectively a trough and a jutting ring held in the trough. The action member 40 and the rotary switch 20 also have respectively a first fastening portion 43 and a second fastening portion 22 corresponding to each other to form fastening relationship therewith. The first fastening portion 43 and the second fastening portion 22 are respectively a latch hook and a latch trough that are latchable with each other. The action member 40 has a housing trough 45 to hold an elastic support element 46 which may be a spring as shown in the drawings, but may also be other equivalent elements such as an elastic reed or rubber ring or the like. The elastic support element 46 is interposed between the action member 40 and the rotary switch 20 to separate the action member 40 from the click member 30.

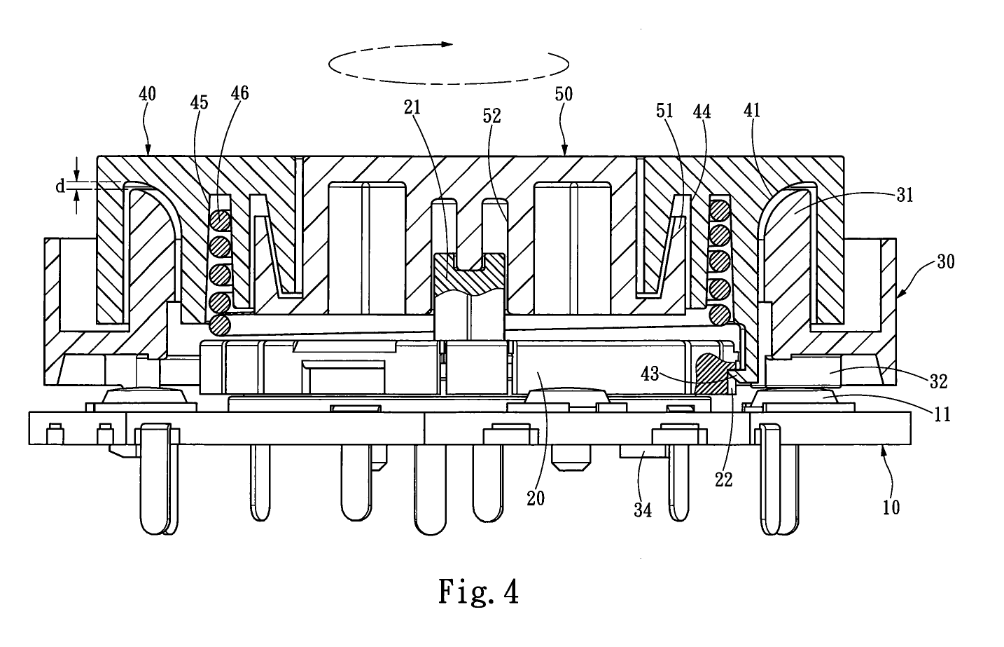

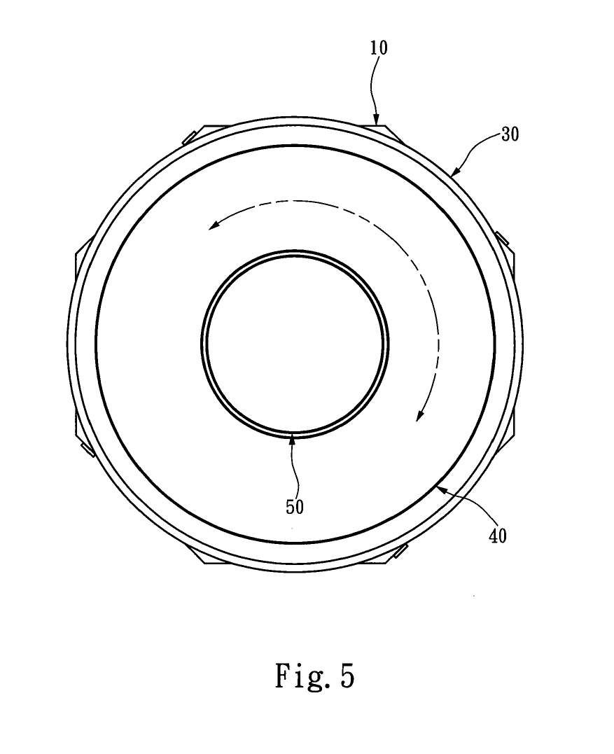

Referring to FIGS. 4 and 5, the elastic support element 46 provides an elastic force in regular conditions to space the action member 40 from the click member 30 at a gap d. Hence when the action member 40 drives the rotary switch 20 rotating the click member 30 does not rotate therewith. As the click member 30 is not in contact with the action member 40 in such a condition, the action member 40 can rotate smoothly without touching the click member 30 and delivering directional commands mistakenly.

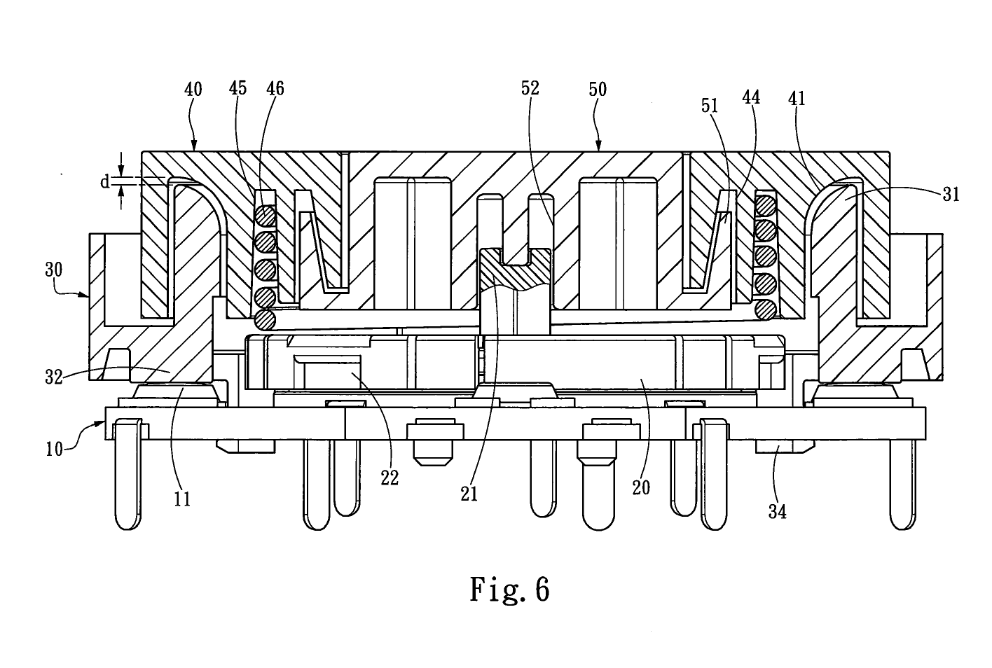

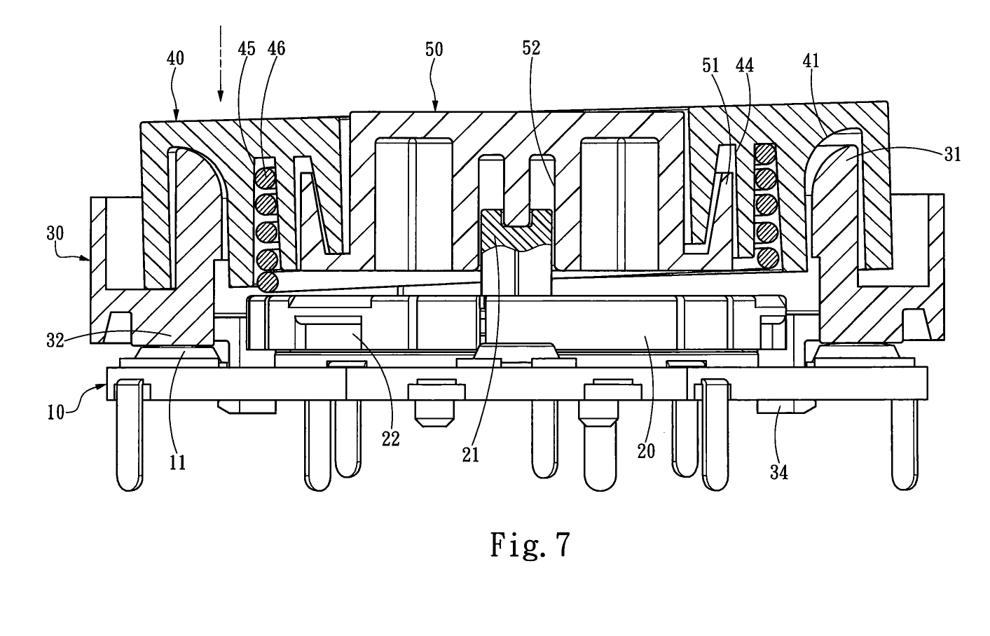

Also referring to FIGS. 6 and 7, initially the action member 40 and the click member 30 are supported respectively by the elastic element and the directional switch 11 on the base board 10. When there is a desire to output a directional command, referring to FIG. 7, applying a depressing force on the action member 40 to generate a click displacement to compress the elastic support element 46. The first coupling portion 41 of the action member 40 and the second coupling portion 31 of the click member 30 make contact with each other to push the click member 30. Upon receiving the depressing force from the action member 40, the click portion 32 of the click member 30 compresses the directional switch 11 on the base board 10 to output the directional command.

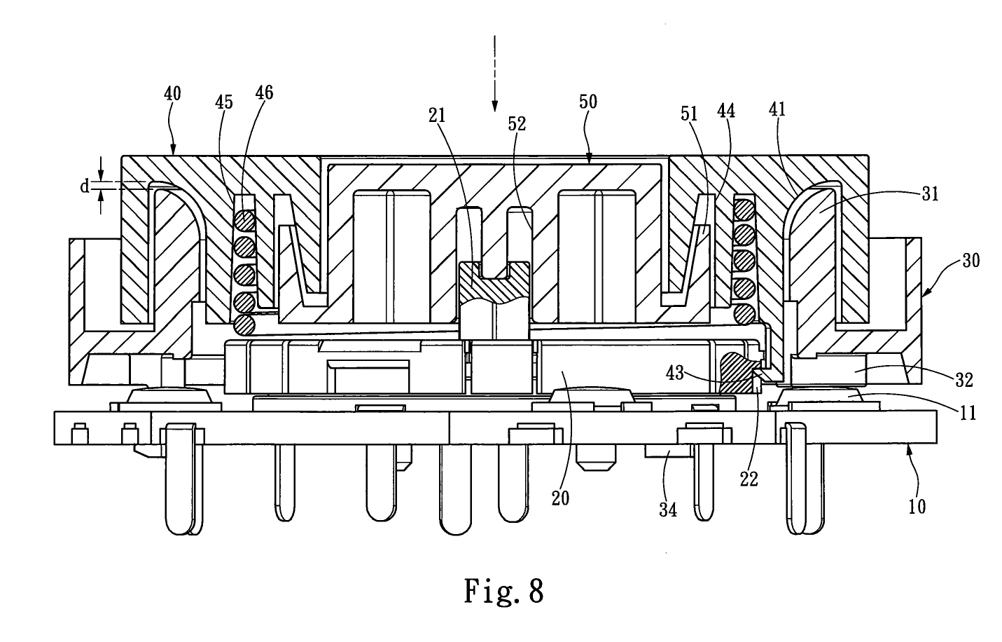

In this embodiment, the rotary switch 20 also has a button switch 21, and the action member 40 has a housing orifice 42 to hold a control button 50 of the button switch 21. The action member 40 and the control button 50 have respectively a first retaining portion 44 and a second retaining portion 51 so that the control button 50 can be retained in the housing orifice 42 without escaping the action member 40. The first retaining portion 44 and the second retaining portion 51 are respectively a trough and a jutting ring held in the trough to prevent moisture from entering through a gap formed between the action member 40 and the control button 50. The control button 50 further has an anchor cavity 52 to hold the button switch 21 so that in addition to delivering the rotational commands and directional commands through the action member 40, the invention also can output a click command by depressing the control button 50 to drive the button switch 21 downwards as shown in FIG. 8.

As a conclusion, the invention provides the elastic support element 46 to support the action member 40 to form a gap d between the action member 40 and the click member 30. Thereby the action member 40 can drive the rotary switch 20 rotating to output rotational commands without interfering the click member 30. Moreover, while the action member 40 is depressed the click portion 32 of the click member 30 is driven to compress the directional switch 11 on the base board 10 to output the directional command. The accuracy of command output improves and mistaken hitting can be prevented. In addition, the second coupling portion 31 of the click member 30 and the corresponding first coupling portion 41 of the action member 40 are positioned in a stacked manner, thus the total size can be shrunk to save space.

Compared with the conventional techniques, the invention provides many benefits, notably:

1. Improve command output accuracy to facilitate user operation.

2. Have a smaller size and is adaptable to smaller electronic devices.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A control structure for multi-instruction switches, comprising:
a base board which has a rotary switch and a plurality of directional switches located on the periphery of the rotary switch, the rotary switch rotating on a rotary track to output rotational commands;
a click member which has a first anchor portion corresponding to a second anchor portion located on the base board to form an anchoring relationship, a housing opening corresponding to the rotary switch and a plurality of click portions corresponding to the directional switches to compress thereof and output directional commands; and
an action member which is mounted onto the click member and has a first coupling portion corresponding to a second coupling portion located on the click member, and a first fastening portion corresponding to a second fastening portion located on the rotary switch to form a fastening relationship therewith, the action member and the rotary switch being interposed by an elastic support element which supports the action member to form a gap with the click member in regular conditions, the action member driving the rotary switch to rotate on the rotary track without interfering the click member to avoid erroneously touching the directional switches, the action member being movable at a click displacement to compress the elastic support element to drive the click member and the directional switches to output the directional commands.

2. The control structure of claim 1, wherein the action member has a housing trough to hold the elastic support element.

3. The control structure of claim 1, wherein the first coupling portion is a trough and the second coupling portion is a jutting ring held in the trough.

4. The control structure of claim 1, wherein the rotary switch has a button switch located thereon.

5. The control structure of claim 4, wherein the action member has a housing orifice to hold a control button of the button switch.

6. The control structure of claim 5, wherein the action member has a first retaining portion and the control button has a second retaining portion.

7. The control structure of claim 6, wherein the first retaining portion is a trough and the second retaining portion is a jutting ring held in the trough.

8. The control structure of claim 5, wherein the control button has an anchor cavity to hold and anchor the button switch.

9. The control structure of claim 1, wherein the first fastening portion is a latch hook and the second fastening portion is a latch trough latchable by the latch hook.

10. The control structure of claim 1, wherein the first anchor portion is a latch hook and the second anchor portion is a latch hole latchable by the latch hook.
